(19) United States
(12) Patent Application Publication
(10) Pub. No.: US 2009/0216646 A1
(43) Pub. Date: Aug. 27, 2009

(54) MERCHANT REWARDS METHODS, SYSTEMS AND PRODUCTS THEREBY

(76) Inventors: Charles Seven, Newport Beach, CA (US); Ryan Seven, Newport Beach, CA (US); Stuart Graham, Newport Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/395,463

(22) Filed: Feb. 27, 2009

Related U.S. Application Data
(63) Continuation of application No. 12/171,222, filed on Jul. 10, 2008.
(60) Provisional application No. 60/948,937, filed on Jul. 10, 2007.
(60) Provisional application No. 60/948,943, filed on Jul. 10, 2007.
(60) Provisional application No. 60/951,686, filed on Jul. 24, 2007.

(51) Int. Cl. G06Q 30/00; G06Q 50/00

(52) U.S. Cl. 705/14

(57) ABSTRACT

A method, system and products thereby for enhanced customer loyalty program with improved access to restaurant information. The system having a server configured to perform operations including storing data including at least an identifier associated with a customer account in the customer rewards program, the identifier corresponding to a registered credit card number. The server may be further configured to receive the data from a merchant terminal relating to a qualified purchase, the merchant terminal being located at one of the plurality of independent merchants participating in the closed coalition customer rewards program, and verify a customer's membership in the closed coalition customer rewards program. Additionally, the server may be further configured to transfer an award associated with the qualified purchase transaction to the customer account, and process a customer's directive for redeeming the award for use at the participating restaurant.

### RELATED APPLICATION

This application claims the benefit of and priority to U.S. patent application Ser. No. 12/171,222, filed Jul. 10, 2008, which claims the benefit of and priority to U.S. Provisional Application Ser. Nos. 60/948,937, filed Jul. 10, 2007; 60/948,943, filed Jul. 10, 2007; 60/951,686, filed Jul. 24, 2007; and U.S. Utility patent application Ser. No. 11/953,786, filed Dec. 10, 2007, the contents of each of which are incorporated by reference herein in its entirety.

### FIELD OF THE DISCLOSURE

The present disclosure relates generally to methods for managing customer rewards relative to local vendor and merchants including improvements and enhancements driven by electronic commerce (e-commerce) applications and registered card technology.

### BACKGROUND OF THE DISCLOSURE

One of the most common concerns for many businesses is the need to develop fresh ways to acquire new customers and to retain current customers. There are currently a number of rewards programs in place across many different merchants that attempt to build customer loyalty and attract new consumers. These types of programs tend to reward consumers for shopping frequently at the sponsoring merchant and are usually tied to the amount, not just the number, of purchases as well.

Another approach to attracting customers is the use of coupons. As is well known, coupons are distributed through many different channels and, when presented at the time of purchase, provide an instant discount off an item or items. Coupons can be related to a particular product or a particular merchant. Thus, coupons may be sponsored by a manufacturer or by a merchant. Coupons have a number of draw-backs from the perspective of the merchant. One drawback is that in the view of some consumers, the use of coupons carries some stigma for both the consumer and the merchant. Accordingly, consumers who are embarrassed to use coupons are not attracted to a merchant by coupons regardless of their savings. Additionally, tracking coupons to determine which distribution channels were effective and to identify useful consumer trends or information has proven difficult.

Thus, an unmet need exists for a customer acquisition and retention program that overcomes the problems of traditional coupons and rewards programs.

### SUMMARY OF INVENTION

A system for promoting customer loyalty to a plurality of independent restaurants participating in a closed coalition customer rewards program is provided. The system may include a memory and a processor. The memory stores data including at least an identifier associated with a customer account in the customer rewards program, the identifier corresponding to a registered credit card number. The processor may be configured to receive the data from a restaurant terminal in connection with a qualified purchase of a menu item at a participating restaurant, and verify a customer's membership in the customer rewards program. The processor may also be configured to transfer an award associated with the purchase of the menu item to the customer account, and process a customer's directive for redeeming the award for use at one of the plurality of participating restaurants. In one embodiment, the award may be a dollar amount, a cash value or a credit point.

In one embodiment, the processor may further be configured to trigger the issuance of at least one check, credit voucher, electronic equity place holder, or a diner rewards card with a certain face value for redeeming the award. The processor may also be configured to accumulate, in the customer account, additional awards associated with other purchase transactions. The processor may also be configured to accumulate separate awards in the customer account, each being redeemable at the independent participating restaurant where qualified purchase transaction took place. In one embodiment, the processor is further configured to prompt the customer to input at least one credit card number for association with the customer account.

According to a feature of the present disclosure, a machine-readable medium is disclosed. The machine-readable medium provides instructions, which when read by a processor, cause the machine to perform operations including storing, in a database, a merchant data for a plurality of independent merchants participating in a closed coalition customer rewards program. The machine-readable medium may also provide instructions, which when read by a processor, cause the machine to perform operations including storing, in the database, at least one credit card data associated with a customer account in the closed coalition customer rewards program, and receiving electronic notification from one of the plurality of independent merchants. Optionally, the machine-readable medium may also provide instructions, which when read by a processor, cause the machine to perform operations including transferring an award associated with the qualified purchase transaction to the customer account, and processing a customer's directive for redeeming the award for use at the participating restaurant.

In one embodiment, the machine-readable medium may provide instructions, which when read by a processor, cause the machine to perform operations including providing the plurality of independent merchants of customer transaction history associated with the at least one credit card data. The machine-readable medium may also provide instruction for transmitting the merchant data to a customer terminal for display of information on the plurality of independent merchants participating in a closed coalition customer rewards program.

### DRAWINGS

The above-mentioned features and objects of the present disclosure will become more apparent with reference to the following description taken in conjunction with the accompanying drawings wherein like reference numerals denote like elements and in which:

FIG. 1 schematically illustrates a merchant rewards system, according to one embodiment of the present disclosure.

FIG. 2 likewise schematically illustrates an exemplary Web-based search result for a certain menu item, according to one embodiment of the present disclosure.

FIG. 3 further schematically illustrates a recommendation of a restaurant based upon a record of a customer's past dining experience, according to one embodiment of the present disclosure.

FIG. 4 is an exemplary flowchart outlining the operation of a merchant rewards web site for enhanced customer access to merchant information, according to one embodiment of the present disclosure.

FIG. 5 is an exemplary flowchart outlining the operation of a merchant rewards server for an enhanced customer loyalty program, according to one embodiment of the present disclosure.

FIG. 6 is an exemplary flowchart outlining the operation of a restaurant rewards server for an enhanced customer loyalty program with improved access to restaurant information, according to one embodiment of the present disclosure.

### DETAILED DESCRIPTION

In the description that follows, the present invention will be described in reference to preferred embodiments for merchant rewards methods, systems and products thereby. The present invention, however, is not limited to any particular application nor is it limited by the examples described herein. Therefore, the description of the embodiments that follow are for purposes of illustration and not limitation.

The merchant rewards system may be used to provide advanced search engine capability and/or registered card technology with an enhanced customer loyalty program. In one embodiment, the merchant rewards system may be used specifically for a restaurant customer loyalty program, such as one provided and promoted by a coalition of independent restaurants. The merchant rewards system may be coupled to a network, such as the Internet, and accessible via an Internet website.

The search engine may be used to provide advanced searching capability of individual menu items as opposed to simply a cuisine. For example, the search engine may be used to search for restaurants that offer a California roll in a specific locality. A list of restaurants offering the desired dish or menu item may be provided from the search. Alternatively, the restaurants offering the desired dish or menu item may be mapped out on a Google® map or an equivalent thereof.

Additional filtering capability may be provided to the customer to further enhance the customer's experience in selecting a restaurant with a desired menu item. For example, the search engine may have filtering criteria such as, but not limited to, ocean view, valet parking, amenities, bar service, live band, sports TV, Karaoke, handicapped accessibility, chef bios, awards, etc.

In one embodiment, the customer loyalty program may be used to provide customers with incentives to dine at certain restaurants. For example, the customer loyalty program may allow customers to purchase a gift certificate from the internet with a face value greater than its sate price. The gift certificate may be mailed to or printed out by the customer. Another example include providing a customer with a diner rewards card that allows accumulation of dollar amount, cash value or credit points in a customer account associated with the diner rewards card. The customer uses the diner rewards card at a participating restaurant, which transmits via a point-of-sale terminal or register to the merchant rewards system for accumulation of dollar amount, cash value or credit points in the customer account. In yet another example, the customer may be mailed a free diner rewards card with a certain face value (i.e. $20) that is redeemable at any participating restaurant. In one embodiment, the customer may register his/her credit card using registered card technology described herein to realize the same benefits of a diner rewards card without the hassles of carrying an extra loyalty card. In another example, the customer may be mailed a checkbook for use at participating merchants as detailed below.

The customer loyalty program may utilize different membership classes, for example, based on the number of times a customer has dined out at a participating restaurant. In one embodiment, the membership classes may be identified as Bronze, Silver, Gold and Platinum, whereby the Bronze member has dined out at a participating restaurant far less than the Platinum member. According to one embodiment, different awards may be provided to the different membership classes.

One novel aspect of the present disclosure is identifying menu items for certain diet plans. For example, identifying menu items at a certain restaurant that are acceptable under the South Beach Diet®. As can be envisioned by a person skilled in the art, the customer can utilize the search engine to identify a dish or menu item that is acceptable under a certain diet plan. In one embodiment, diet companies may endorse or recommend a certain dish or menu item at a restaurant, allowing its customers to remain on the diet while dining out.

The merchant rewards system may be used to provide recommendations of restaurants similar to ones that the customer has dined in. As can be appreciated, a customer's diner rewards card, when swiped at a point-of-sale terminal in a restaurant, allows the transmission and collection of the customer's dining information by the merchant rewards system, such as, restaurant name, type of cuisine, and type of dish or menu item selected by customer at the restaurant. Once such data is received by the merchant rewards system, the system may dynamically determine restaurants of similar criteria to suggest or recommend to the customer upon future log-in to the merchant rewards system.

As is understood by a person skilled in the art, any means of customer identification may be used other than a diner rewards card, such as, but not limited to, radio frequency ID, hologram, fingerprint, voice print, retina print, etc. In one embodiment, registered card technology may be used to identify a customer enrolled in the merchant rewards system. For example, a customer may complete a form at a merchant location. The form may include fields, such as but not limited to, the customer's name and e-mail. The merchant may then enter the information in the merchant rewards system. An e-mail may be transmitted from the merchant rewards system to the customer to register one or more credit cards for association with a customer account. As such, the customer need not provide credit card information to the merchant directly at the time of enrollment, but may be provided securely instead, at a later time, to the merchant rewards system employed in a closed loop/coalition of independent merchants. In one embodiment, the customer may register different credit cards for different merchants and accrue a separate award, such as a dollar amount, a cash value or a credit point, independently for each merchant. As such, the merchant rewards system improves customer loyalty for a plurality of independent merchants without the hassle for customers to carry multiple loyalty cards and without the hassle for the plurality of independent merchants to separately manage and administer a loyalty program for their customers.

As can be appreciated by a person skilled in the art, the merchant rewards system may be accessed through the internet via a merchant rewards website. The website may provide enhanced customer access to merchant information through various options and software applications. For example, the website may provide a message board where restaurants and customers can communicate back and forth, in real time or delayed time. The website may also provide customers with an opportunity to review or rate restaurants and/or individual menu items at a restaurant. In one embodiment, the website may prompt a customer who used the diner rewards card or registered credit card at a participating restaurant to review and/or rate the participating restaurant. The website may also prompt a customer who used the restaurant search engine for locating a participating restaurant to review and/or rate the participating restaurant. As such, other customers will have an opportunity to read reviews and ratings of restaurants based on at least one customer's dining experience. In addition to providing access to individual menu items at participating restaurants, the website may also provide customers with an opportunity to order online or place an order for take out. The website may also provide enhanced customer access to merchant information by providing merchants with a standard or custom design webpage that may be linked to and/or integrated with the merchant rewards website.

In one embodiment, the merchant rewards system may be used to provide and/or facilitate merchant related services. For example, the merchant rewards system may be integrated with a merchant computer to facilitate ordering, processing, billing, timekeeping, etc. The merchant rewards system may also facilitate printing of coupons.

As can be appreciated by a person skilled in the art, the merchant rewards system may connect diners to their favorite restaurant through a “favorites” system which enables restaurants to send offers to diners who have added that particular restaurant to their favorites on the merchant rewards website. These offers incentivize diners to add restaurants they frequent to their favorites and it also incentivizes restaurants to make offers available to incentivize users to add them to their favorites.

In one embodiment, a merchant may provide promotional material (i.e. coupons, rebates, etc.) to the general public or specifically fans of the restaurant. A customer may become a fan for any restaurant by selecting the restaurant as a favorite on the merchant rewards website, thereby providing a favorite restaurant designation to the merchant rewards system. A customer can add as few or as many restaurants to their favorites as they like. All offers from their favorites may be displayed on a single page that a user can check anytime before they make a decision on where to dine out at. As offers expire and change, this mechanism will be a primary drive of traffic and answers to the question of what a user can do outside of searching for restaurants.

The merchant rewards server may also be configured to provide autonomous restaurant recommendations. In one embodiment, as users go about rating restaurants, menu items, print coupons, and add restaurants to their favorites, the merchant rewards server may develop a user customer profile. This customer profile allows the merchant rewards server with the ability to recommend restaurants and dishes that they would most likely enjoy. Much like a personality test, this customer profile may be placed on an individual's MySpace® page, Facebook® page, or any other social networking or blog site.

According to one embodiment of the present disclosure, the merchant rewards system provides improved city, locality, region and other individually-based vendor services for enhanced customer access. Expressly, incorporated herein by reference, as it fully set forth herein is U.S. Pat. No. 6,896,188. In one embodiment, the merchant rewards system functions in conjunction with the same.

A “check” as defined herein comprises at least one of a tangible manifestation of a draft, as set forth in U.S. Pat. No. 6,896,188 and any electronic analogue or home log thereof.

The benefit to the consumer is evident. The consumer is able to save money on everyday shopping at quality retailers and merchants. Furthermore, the consumer can avoid the hassle and embarrassment that often accompany the use of traditional coupons.

The merchants benefit in a number of ways. By partnering with only certain types of issuers, the merchant has some control of the demographic to which its checks are distributed thereby avoiding distribution costs to demographic segments that are not interested in that merchant. The merchant may also place conditions on redeeming the check that ensure a certain amount of money will be spent when the check is redeemed. Additionally, a merchant that other-wise may not use coupons is able to offer a similar benefit that does not detract from its image or the image of its merchandise.

The issuers benefit by offering a premium that attracts consumers. The checkbook premium, diner rewards card and/or registered credit card are attractive to consumers both economically and aesthetically. Also, the checkbook premium is unique in the marketplace and helps distinguish the issuer over its competitors. Thus, the checkbook premium offers a way for the issuer to easily and effectively attract and retain customers.

One party not discussed yet is the checkbook publisher. The publisher creates the relationship between the merchants and the issuers that allow the checkbook to be attractive to consumers and, thus, attractive to the issuers and merchants. The publisher offers the merchant a way to distribute the checks without the merchant incurring printing and distribution costs. The publisher offers the issuer a premium that costs far less than its value to consumers and is distinguishable in the marketplace.

The publisher contacts quality retailers that may be reluctant to participate in a coupon program or who provide everyday services and products to the average consumer. The checkbook publisher also contacts potential issuers and explains the benefits of the checkbook premium. The issuers contacted are those issuers that will likely attract a demo-graphic that is attractive to the merchants. if necessary, the publisher can provide market surveys and other data that supports the conclusion that the checkbook premium is an attractive premium for many consumers.

For example, the merchants and publisher can jointly determine a number of characteristics of how the checks were used by consumers. By collecting information from a number of merchants, the coded information may be used to determine which issuers appeared to drive more customers to which merchants. The coded information may also be used to determine which checkbook (i.e., which consumer) was used at multiple merchants and thus identify opportunities for cross marketing or targeted marketing.

In one embodiment, a checkbook may be issued to a customer based on accumulation of dollar amount, cash value or credit points in the customer account. For example, if the customer accumulates 5000 points, he may be issued a checkbook with 5 checks, each having a face value of $20 and can be used at any participating restaurant. As is understood by a person skilled in the art, while a checkbook with multiple checks may be issued to a customer, the customer may be issued one check to redeem the accumulated dollar amount, cash value or credit points. For example, the customer may be issued one check with face value $100 to redeem 5000 points accumulated in the customer's account.

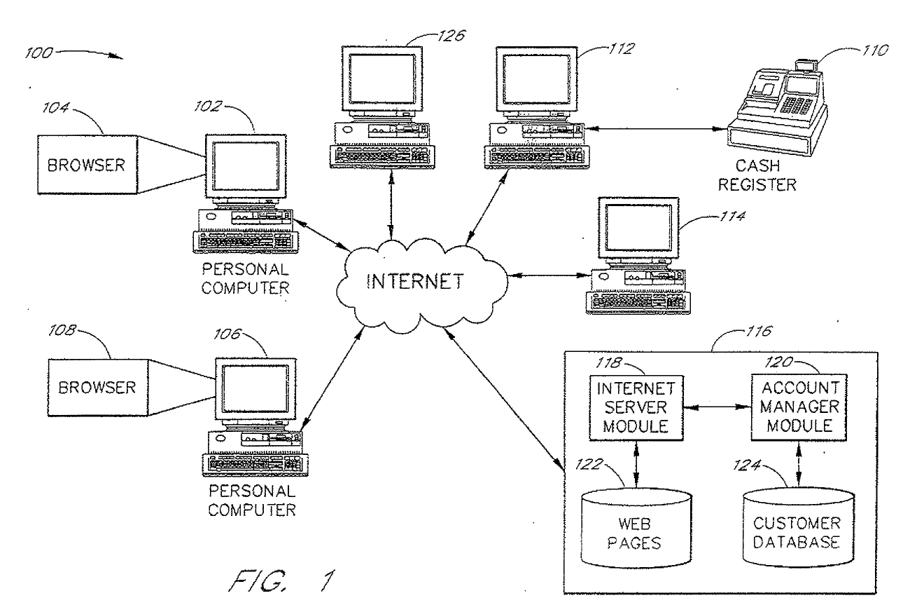

FIG. 1 illustrates exemplary basic hardware and/or software modules used to implement one embodiment of the merchant rewards system 100. As illustrated, customers may access the merchant rewards web site 116 using respective personal computers, 102, 106 or other terminals, such as phone and personal digital assistants, that have access to a network, such as the Internet. The customer computers 102, 106 may run commercially-available Web browser applications 104, 108 such as Microsoft Internet Explorer®, which implements World Wide Web standards such as HTTP, HTML, XML, Java, Flex, Ajax and the like.

The merchant computers or servers 112, 114 may be implemented using mainframe computers, minicomputers, personal computers, and the like. The merchant computers 112, 114 may be networked or otherwise coupled to a point-of-sale terminal or register 110. Information related to the purchase is relayed from the merchant computers 112, 114, to the merchant rewards website 116 over the Internet, private network, or using other techniques for transferring digital data, such a magnetic tape. The information may be relayed in real-time, or periodically, such as once a day. In one embodiment, the information may include a restaurant name, type of cuisine, type of dish or menu item selected by the customer at the restaurant. Dollar amount, cash value or credit points may then be transferred to and/or accumulated in the customer's merchant rewards customer account.

The merchant rewards website 116 may include a computer server system and software modules, as well as associated content accessible using the Internet. The website content may be distributed over several Internet domains, and may be implemented using several servers located at various locations. Of course, a variety of networks, both public and private, may be used as well. The merchant rewards website 116 may use a commercially-available Internet server 118 which accesses a database 122 that may be used to store and/or dynamically generate Web pages in response to end user actions. The Web pages may be in the form of HTML pages or the like.

The computer server 118 may include an interface control system (not shown) and a processor (not shown). The interface control system may be used to provide an interface with the merchant rewards website 116. The interface control system may include an interface unit (not shown) for receiving an identifier of a merchant rewards customer account transmitted during or after a purchase transaction. The interface unit may also be used to provide search results executed by website search engine to the customer's computer 102 or 106. Furthermore, the interface unit may also be used to provide access to customer and merchant accounts.

The interface control system may also include a verification unit (not shown) coupled to the interface means for verifying a customer's enrollment in the merchant rewards program from the identifier received by the interface unit. Additionally, the interface control system may include a qualification unit (not shown) coupled to the interface unit for controlling the transfer and accumulation of dollar amount, cash value or credit points in a customer's account. The qualification may be based at least in part on a purchase of a product from a participating merchant and the transfer of customer's identifier encoded in the diner rewards card or assigned to a registered credit card.

The processor may be used to process applications selected by a customer or merchant, for example, computing the total dollar amount, cash value or credit points accrued in a customer account, or generate a merchant webpage integrated with the merchant rewards website 116 in accordance with merchant's directives and data uploaded to the merchant rewards website 116. In one embodiment, the processor may be configured to receive the identifier from a restaurant terminal via the interface control system. The identifier is transmitted by the restaurant terminal in connection with a qualified purchase of a menu item at a participating restaurant. The processor may be configured to verify a customer's membership in the customer rewards program by comparing the transmitted identifier with customer records in database 124. The processor may also be configured to transfer an award, such as a dollar amount, a cash value or a credit point, associated with the purchase of the menu item to the customer account, and process a customer's directive for redeeming the award for use at one of the plurality of participating restaurants.

As can be appreciated, the processor may further be configured to trigger the issuance of at least one check or a diner rewards card with a certain face value for redeeming the award. The processor may also be configured to accumulate, in the customer account, additional awards associated with other purchase transactions. Additionally, the processor may be configured to retrieve, from database 124, restaurant data of the participating restaurant in response to a search engine command. The retrieved restaurant data may be mapped out by location. In one embodiment, the processor may also be configured to receive a customer review of the participating restaurant.

The Web site 116 may include an account manager application module 120. The account manager application module 120 may be used to handle customer and merchant accounts. The customer account may be used to accumulate dollar amount, cash value or credit points earned from a purchase transaction, for example, dining at a participating restaurant. The customer account may also be used for accessing message boards, reviewing and/or rating merchants, and selecting favorite restaurants for a restaurant fan club. The merchant account may be used to set up a merchant webpage integrated with the merchant rewards website 116. The merchant account may also be used to list menu items, upload pictures of menu items, upload pictures of the restaurant, provide e-mail access, provide access to message board for correspondence with potential customers, request merchant related services, identify diet friendly menu items, etc.

The account manager application module 120 may be used to access a customer database 124 that stores customer-related information, such as name of restaurants that customer dined in, type of cuisine, type of dish or menu item selected by customer at the restaurant, the accumulated dollar amount, cash value or credit points earned from dining at participating restaurants, reviews and ratings of restaurants by the customer, and the names of favorite restaurants.

The database 122, 124 can be implemented in a machine-readable medium, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. The database 122, 124 may be used to store, arrange and retrieve data.

Records of restaurants that a customer dined in may be retrieved from the database 124 for processing by the account manager application module 120. The module 120 may be used to dynamically determine restaurants of similar criteria to suggest or recommend to the customer upon future log-in to the merchant rewards website 116.

The account manager application module 120 may also be used to manage recommendations or endorsements from diet companies for select menu items. For example, the computer system 126 may be associated with a diet company, such as Atkins™ diet company, that transmits via the internet a recommendation or endorsement of a menu item to the website 116. The diet company may log on to a diet company account that may be managed by the account manager application module 120. The diet company places a recommendation or endorsement of a menu item, which may be stored in database 124 and retrieved when a customer or merchant selects to view the menu item on the merchant rewards website 116.

As previously discussed, customers, merchants and/or diet companies may examine and/or edit their accounts using a terminal or phone to access their accounts stored in the customer database 124.

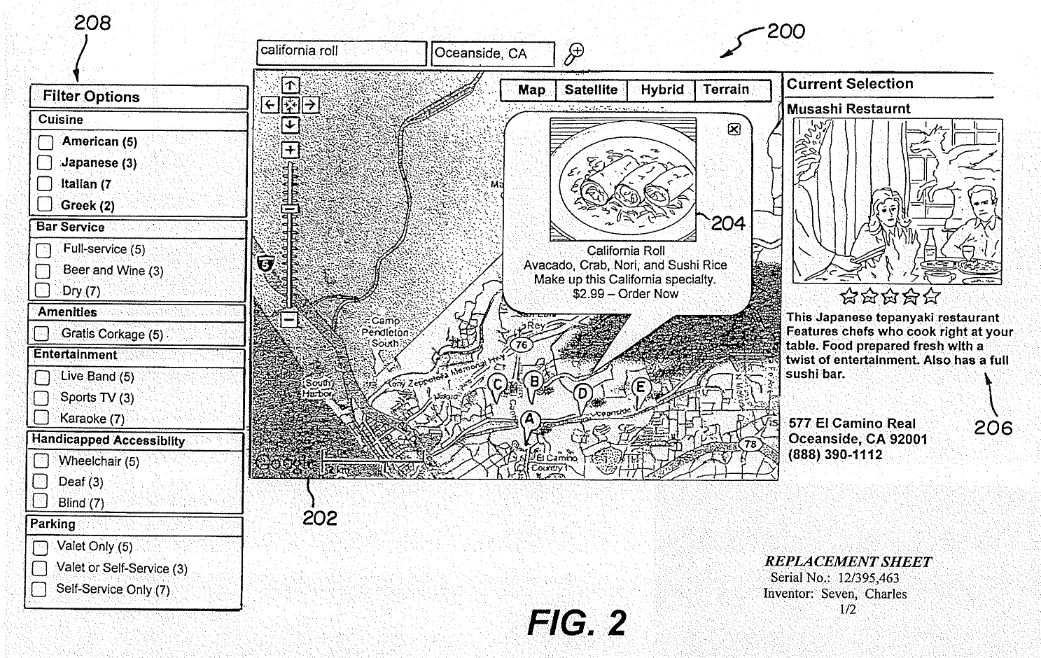

FIG. 2 illustrates an exemplary Web-based search result 200 for a certain menu item, according to one embodiment of the present disclosure. The exemplary search result maps out on Google® map 202 all participating restaurants in Oceanside, Calif. that offer California roll on its menu. Upon selection of an identified location on Google® map, for example, selecting location “D”, a picture image 204 of the dish offered at the restaurant may be displayed. Additionally, the price of the menu item and additional information on the menu item may be provided. In one embodiment, the website 116 may allow the customer to place an order for the menu item, for example, for take out. Additional information 206 on the restaurant may be provided, including indoor or outdoor views, description of entertainment offered, address and telephone number.

Additional filtering options 208 may be provided to further enhance the customer's experience in selecting a restaurant. For example, the filtering options may include, but not limited to, cuisine, bar service, amenities, entertainment, handicapped accessibility, and parking.

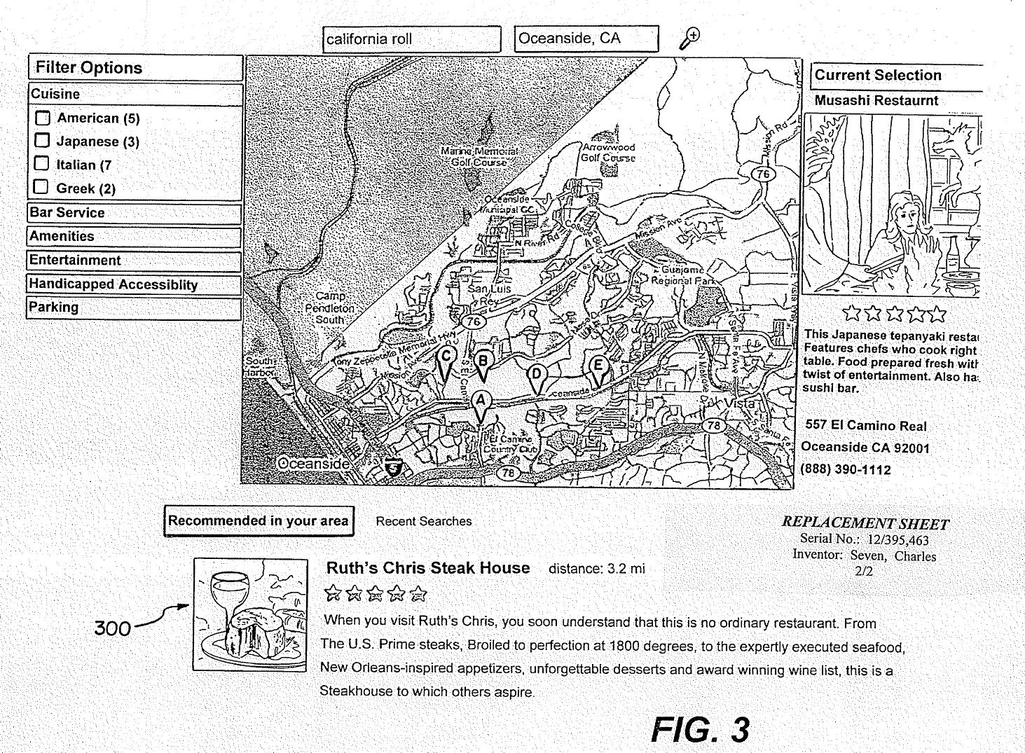

FIG. 3 illustrates a recommendation 300 of a restaurant based upon a record of a customer's past dining experience, according to one embodiment of the present disclosure. Records of restaurants that a customer dined in may be retrieved from the database 124 for processing by the account manager application module 120. The module 120 may be used to dynamically determine restaurants of similar criteria to suggest or recommend to the customer upon future log-in to the merchant rewards website 116.

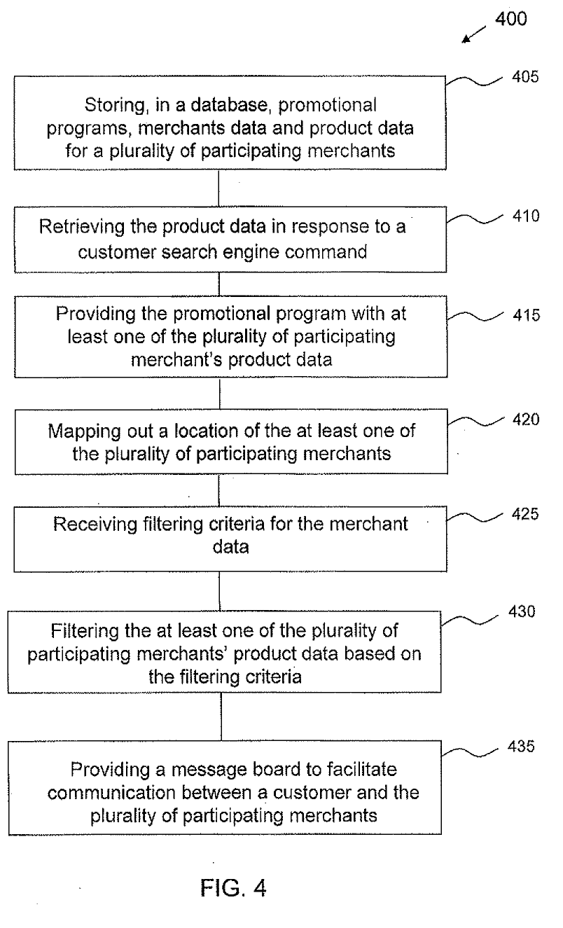

FIG. 4 is an exemplary flowchart 400 outlining the operation of a merchant rewards web site 116 for enhanced customer access to merchant information, according to one embodiment of the present disclosure. The web site 116 may store, in database 124, promotional programs, merchant data and product data for a plurality of participating merchants (405). The promotional program may include an offer to purchase a gift certificate with face value greater than its sale value. The promotional program may also include a rewards card redeemable at a participating merchant. The merchant data may include merchant information, such as, but not limited to, cuisine, bar service, amenities, entertainment, handicapped accessibility, and parking. The product data may include images and information on every product offered by a participating merchant. The website 116 may be used to retrieve the product data in response to a customer search engine command (410). In one embodiment, the website 116 may provide the promotional program with at least one of the plurality of participating merchants' product data (415). The website 116 may also map out a location of the at least one of the plurality of participating merchants (420). In one embodiment, the website 116 may provide filtering options for the merchant data. The website 116 may receive filtering criteria for the merchant data (425) and filter the at least one of the plurality of participating merchants' product data based on the filtering criteria (430). In one embodiment, the website 116 may provide a message board to facilitate communication between a customer and the plurality of participating merchants (435).

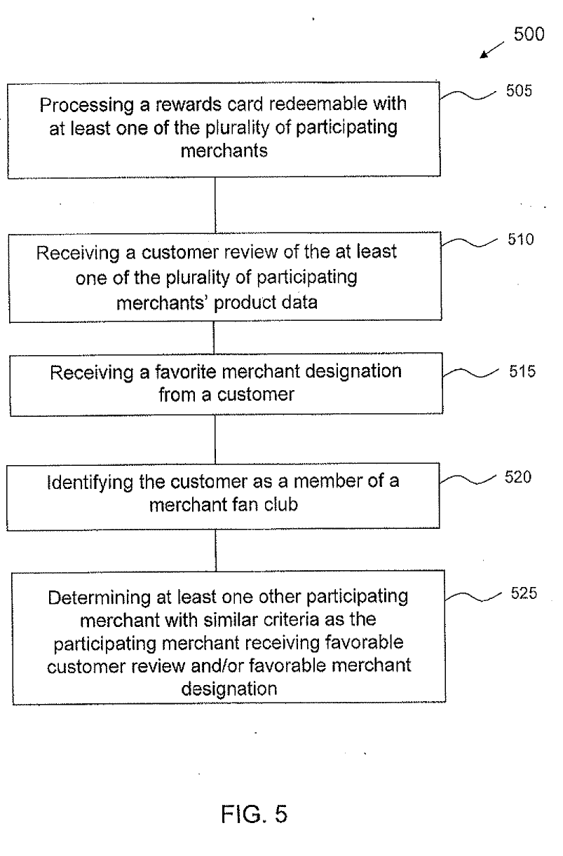

FIG. 5 is an exemplary flowchart 500 outlining the operation of the merchant rewards server 118 for an enhanced customer loyalty program, according to one embodiment of the present disclosure. The server 118 may be configured to process a rewards card redeemable with at least one of the plurality of participating merchants (505). In one embodiment, the server 118 may be configured to process a customer's credit card associated with a customer account using registered card technology. The rewards card or registered credit card have an identifier encoded therewith or number assigned thereto that is associated with a customer account. The processing of the rewards card or registered credit card may signal a qualified purchase of a product at a participating merchant. The customer may then be prompted to provide a customer review of the product upon log in to the web site 116. The server 118 may receive the customer review of the at least one of the plurality of participating merchants' product data (510). In one embodiment, the server 118 may also receive a favorite merchant designation from at least one customer (515), and identify the at least one customer as a member of a merchant fan club (520). As can be appreciated by a person skilled in the art, the merchant's promotional program may be provided only to the members of the merchant fan club. In another embodiment, the server 118 may further be configured to determine at least one other participating restaurant with similar criteria as the participating merchant receiving favorable customer review and/or favorable merchant designation (525). As can be appreciated, similar criteria may include the same filtering options as provided by the web site 116 in step 430.

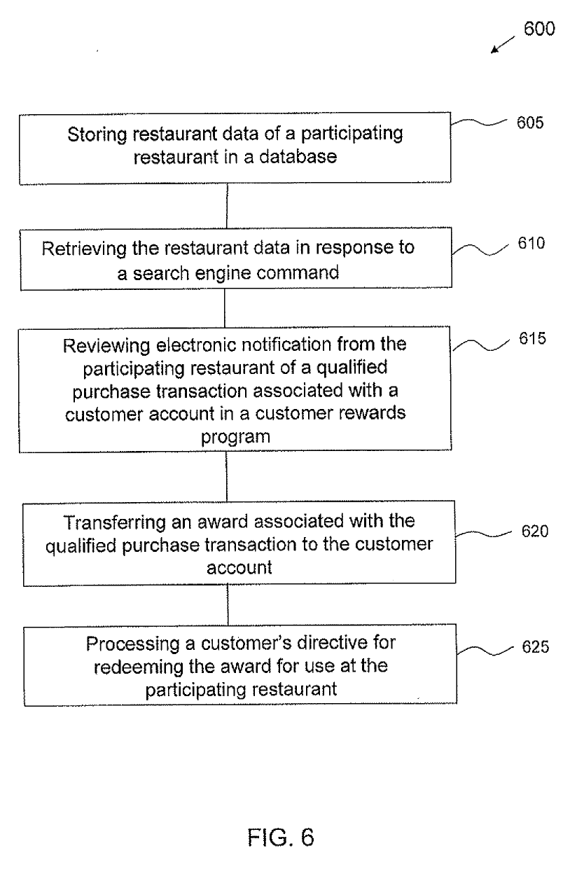

FIG. 6 is an exemplary flowchart 600 outlining the operation of a restaurant rewards server 118 for an enhanced customer loyalty program with improved access to restaurant information, according to one embodiment of the present disclosure. The server 118 may be configured to store restaurant data of a participating restaurant in a database (605) and retrieve the restaurant data in response to a search engine command (610). The restaurant data may include restaurant menu items, and related images, descriptions and prices. The server 118 may be further configured to receive electronic notification from the participating restaurant of a qualified purchase transaction associated with a customer account in a customer rewards program (615). The server 118 may then transfer an award associated with the qualified purchase transaction to the customer account (620). In one embodiment, the server 118 may also process a customer's directive for redeeming the award for use at the participating restaurant (625).

As can be envisioned by a person skilled in the art, the systems, methods and machine-readable mediums may be used to provide enhanced customer loyalty with improved access to merchant information. Although the present invention has been described and illustrated in detail, it is clearly understood that the same is by way of illustration and example only and is not to be taken by way of limitation, the spirit and scope of the present invention being limited by the terms of the appended claims and their equivalents. For example, other embodiments of the present invention contemplate different versions of the checkbook to cater to different demographics or different groups. The different checkbooks may simply have a different physical appearance that is meant to attract a desired demographic or the actual contents (i.e., the checks) of the different versions may reflect merchants that are attractive to certain demographics.

For example, there could be a sports checkbook, a woman's checkbook, a children's checkbook etc. Also, a different checkbook appearance may be offered to each issuer to allow customized branding or other logos to appear on the checkbook. One exemplary embodiment of the present invention contemplates offering exclusivity to merchants in the checkbook. For example. In a particular geographic location only one chain of home-improvement stores will be allowed to have a check in the checkbook. Thus, in this embodiment, the merchant receives another benefit in that consumers receiving the checkbook are driven to that merchant and away from their competitors.

With the growth of the Internet, a number of merchants now have a significant online presence and alternative embodiments of the present invention contemplate checks that may be redeemed via an online transaction. Thus, a check may be redeemed at a “bricks and mortar” merchant or at an online merchant. For merchants having both a physical and an online presence, the check may be redeemed at either location. For example, the alphanumeric information on the check or checkbook may include a redemption code that a consumer would use to redeem a check online. Alternatively, a separate and specifically online code may be printed on the check thereby allowing the consumer to redeem the check online.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

While the method has been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system for promoting customer loyalty to a plurality of independent restaurants participating in a customer rewards program, the system comprising:
a memory for storing data including at least an identifier associated with a customer account in the customer rewards program, the identifier corresponding to a registered credit card number; and
a processor configured to:
receive the data from a restaurant terminal relating to a qualified purchase of a menu item at a participating restaurant,
verify a customer's membership in the customer rewards program,
transfer an award associated with the purchase of the menu item to the customer account, the award selected from a group consisting of a dollar amount, a cash value and a credit point, and
process a customer's directive for redeeming the award for use at one of the plurality of independent participating restaurants.

2. The system of claim 1, wherein the processor is further configured to trigger the issuance of at least one check, credit voucher, or related electronic equity place holder for redeeming the award.

3. The system of claim 1, wherein the processor is further configured to trigger the issuance of a diner rewards card with a certain face value for redeeming the award.

4. The system of claim 1, wherein the data includes information on the plurality of independent participating restaurants.

5. The system of claim 1, wherein the processor is further configured to accumulate, in the customer account, additional awards associated with other purchase transactions.

6. The system of claim 1, wherein the processor is further configured to accumulate separate awards in the customer account, each being redeemable at the independent participating restaurant where qualified purchase transaction took place.

7. The system of claim 1, wherein the processor is further configured to prompt the customer to input at least one credit card number for association with the customer account.

8. A system for promoting customer loyalty to a plurality of independent merchants in a closed coalition customer rewards program, the system comprising:
a memory for storing a first data including at least an identifier associated with a customer account in the closed coalition customer rewards program, the identifier corresponding to a registered credit card number; and
a processor configured to:
receive the first data from a merchant terminal relating to a qualified purchase, the merchant terminal being located at one of the plurality of independent merchants participating in the closed coalition customer rewards program, and
verify a customer's membership in the closed coalition customer rewards program.

9. The system of claim 8, wherein the processor is further configured to:
transfer an award associated with the purchase of the menu item to the customer account, the award selected from a group consisting of a dollar amount, a cash value and a credit point, and
process a customer's directive for redeeming the award for use at one of the plurality of participating restaurants.

10. The system of claim 9, wherein the processor is further configured to accumulate, in the customer account, additional awards associated with other purchase transactions.

11. The system of claim 9, wherein the processor is further configured to trigger the issuance of at least one check, credit voucher, or related electronic equity place holder for redeeming the award.

12. The system of claim 8, wherein the processor is further configured to accumulate separate awards in the customer account, each being redeemable at the independent merchants where qualified purchase transaction took place.

13. The system of claim 8, wherein the processor is further configured to prompt the customer to input at least one credit card number for association with the customer account.

14. The system of claim 8, wherein the memory further stores a second data including information on the plurality of independent merchants.

15. The system of claim 8, wherein the processor is further configured to:
receive a second data including information on the plurality of independent merchants, from merchant servers operated by the plurality of independent merchants, and
transmit the second data to a customer terminal for display of information on the plurality of independent merchants.

16. A machine-readable medium that provides instructions, which when read by a processor, cause the machine to perform operations comprising;
storing, in a database, a merchant data for a plurality of independent merchants participating in a closed coalition customer rewards program;
storing, in the database, at least one credit card data associated with a customer account in the closed coalition customer rewards program; and
receiving electronic notification from one of the plurality of independent merchants of a qualified purchase transaction associated with the at least one credit card data.

17. The machine-readable medium of claim 16, further comprising providing the plurality of independent merchants of customer transaction history associated with the at least one credit card data.

18. The machine-readable medium of claim 16, further comprising identifying to the plurality of independent merchants the frequency of qualified purchase transactions associated with the at least one credit card data.

19. The machine-readable medium of claim 16, further comprising:
transferring an award associated with the qualified purchase transaction to the customer account; and
processing a customer's directive for redeeming the award for use at the participating restaurant.

20. The machine-readable medium of claim 16, further comprising transmitting the merchant data to a customer terminal for display of information on the plurality of independent merchants participating in a closed coalition customer rewards program.
